(19) United States
(12) Patent Application Publication
(10) Pub. No.: US 2014/0170603 A1
(43) Pub. Date: Jun. 19, 2014

(54) Line drawing apparatus

(71) Applicant: Robert W. Ranftl, Rolling Hills Estates, CA (US)

(72) Inventor: Robert W. Ranftl, Rolling Hills Estates, CA (US)

(21) Appl. No.: 13/694,628

(22) Filed: Dec. 18, 2012

(51) Int. Cl. G09B 11/00

(52) U.S. Cl. CPC G09B 11/00
USPC 434/81

(57) ABSTRACT

A line drawing apparatus includes a generally rectangular housing having a closed back, extending sides and a front panel. The front panel defines a screen aperture which is covered by a display screen. The inner surface of the display screen is coated with a phosphorescent material. A stylus is movably supported within the housing and includes an upwardly directed light source. As the stylus is moved, a lighted trace is produced on the display screen.

### CROSS REFERENCE TO RELATED APPLICATIONS

This application is a Continuation-In-Part of application Ser. No. 13/490,796 filed Jun. 7, 2012 in the name of Robert W. Ranftl entitled LINE DRAWING APPARATUS, the disclosure of which is hereby incorporated herein by reference. This application also claims the benefit of and priority under 35 U.S.C. 119(e) of U.S. Provisional Patent Application No. 61/520,341 entitled LINE DRAWING APPARATUS filed Jun. 7, 2011 in the name of Robert W. Ranftl, the disclosure of which is incorporated herein by reference.

### FIELD OF THE INVENTION

This invention relates generally to art oriented amusement devices and particularly to devices similar to the TRACING DEVICE set forth in U.S. Pat. No. 3,055,113.

### BACKGROUND OF THE INVENTION

Perhaps one of the most long-lasting and popular and drawing or tracing devices available in the art is that set forth in U.S. Pat. No. 3,055,113 entitled TRACING DEVICE filed on behalf of Arthur Grandgean which is popularly known by the trade name “Etch A Sketch” which is manufactured and sold by the Ohio Art Company. This well-known device is relatively simple in fabrication and comprises a generally rectangular housing having a rectangular aperture on its front face which supports a glass screen. A pair of control knobs are rotatably supported at each of the lower corners of the front face of the rectangular housing. Within the housing a quantity of fine grain aluminum powder together with fine grain glass beads is loosely deposited. Each of the control knobs are operatively coupled to a separate endless cable arrangement which is supported by pulleys within the housing disposed at the corner portions of the housing interior. One endless cable is coupled to and controlled by rotation of one knob while the other endless cable is coupled to and controlled by the remaining knob. The upper and lower lengths of one endless cable are joined to the opposed ends of an elongated rigid steel wire extending vertically within the housing. The left and right side lengths of the remaining endless cable are joined to a horizontally extending rigid steel wire which forms a horizontal element. A stylus which supports a finger extension touching the undersurface of the glass screen includes a horizontal bore through which the horizontally disposed wire passes and a vertical bore through which the vertically oriented wire passes. Thus, the stylus is loosely supported upon the two wires at their point of intersection. The stylus is supported upon the wires such that the finger extension rubs the interior surface of the glass screen. As the horizontal stylus control knob is rotated, the pulley system moves the stylus along the horizontally oriented guide wire. Conversely, as the vertical knob is rotated, the pulley system moves the knob along the vertically oriented guide wire.

In operation, the user initially inverts the apparatus and shakes the aluminum powder mixture within the housing causing the mixture of aluminum powder and glass beads to be deposited upon the interior surface of the glass screen. The aluminum powder and glass bead mixture tends to cling to this interior surface giving the glass screen an even gray appearance. The user then etches a dark line upon the glass screen by moving either or both of the stylus control knobs causing the stylus to move beneath the glass screen which in turn causes the finger extension of the stylus to displace the aluminum powder mixture at the point of contact with the interior surface of the glass screen. Because the interior of the housing is not lighted, the etched line upon the glass screen appears darker that the overall color of the aluminum powder mixture. As the user becomes more familiar and skilled with manipulation of horizontal and vertical movement of the stylus using the control knobs, figures may be etched upon the glass screen. The user is able to “erase” the etched lines by simply inverting and shaking the apparatus causing the aluminum powder mixture to be once again evenly and uniformly disposed upon the interior surface of the glass screen.

While the foregoing described Etch A Sketch apparatus has proven to be extremely popular and commercially successful, it has been found to be of limited entertainment value. There remains therefore a continuing need in the art for ever more improved line drawing apparatus which can provide greater entertainment and amusement value.

### SUMMARY OF THE INVENTION

The present invention improves the basic Etch A Sketch device by providing a variety of line drawing combinations of screen and stylus. In one embodiment of the invention, a phosphorescent screen is utilized in combination with a stylus supporting an ultraviolet light emitting diode. This embodiment facilitates the line drawing upon the screen by creating light path lines upon the screen. In variations of the embodiment, a plurality of light emitting diodes are supported upon the stylus facilitating the simultaneous drawing the multiple lines upon the screen. In other embodiments, a screen supports an ultraviolet responsive color change material and the stylus supports one or more light emitting diodes to create lines of color change upon the screen. In still other embodiments, a layer of thermachromic color change paint is supported upon the screen and the stylus supports a heating element in contact therewith. Movement with the heating element causes localized color change on the screen to form lines of one or more patterns. In a still further alternate embodiment of the present invention, a quantity of glow-in-the-dark powder is disposed within the housing and provides a screen which glows in combination with a conventional finger element upon the stylus resulting in a glowing screen upon which dark lines are traced. In a still further embodiment of the present invention, the conventional aluminum powder mixture is used together with a stylus which supports a plurality of finger elements such that a plurality of lines are simultaneously etched upon the glass screen as the stylus is moved.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a partially sectioned front view of a line drawing apparatus constructed in accordance with the present invention;

FIG. 2 sets forth a front view of the line drawing apparatus of FIG. 1 having the screen removed there from;

FIG. 3 sets forth a front view of the line drawing apparatus of FIG. 1 having the housing front removed there from;

FIG. 4 sets forth a partial perspective view of the stylus of the line drawing apparatus shown in FIG. 1;

FIG. 5 sets forth a partially section front view of a further alternate embodiment of the present invention line drawing apparatus;

FIG. 6 sets forth a partially sectioned front view of a still further alternate embodiment of the present invention line drawing apparatus;

FIG. 7 sets forth a partially sectioned perspective view of the stylus of the line drawing apparatus shown in FIG. 6;

FIG. 8 sets forth a partially section front view of a still further alternate embodiment of the present invention line drawing apparatus;

FIG. 9 sets forth a perspective view of the stylus of the line drawing apparatus shown in FIG. 8; and

FIG. 10 sets forth a section view of the stylus shown in FIG. 9.

### DESCRIPTION OF THE PREFERRED EMBODIMENT

By way of overview, the present invention improves and expands upon the basic Etch A Sketch device by employing a variety of different screen materials and different stylus elements in combinations which facilitate drawing or line tracing in a similar fashion to the original Etch A Sketch apparatus. The invention provides alternative line drawing and line tracing cooperating combinations to add amusement and entertainment to the original Etch A Sketch device.

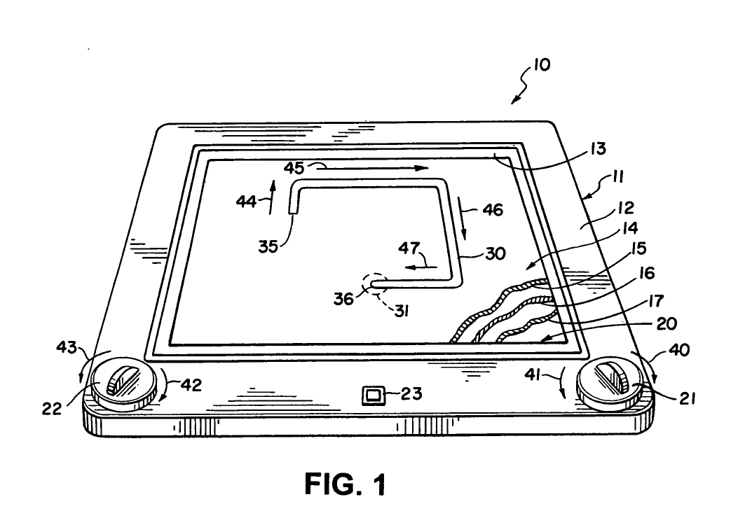

More specifically, FIG. 1 sets forth a partially section front view of a line drawing apparatus constructed in accordance with the present invention and generally referenced by numeral 10. Apparatus 10 includes a generally rectangular housing 11 defining an interior 20 and supporting a generally rectangular screen bezel 13 surrounded by a frame portion 12. Housing 11 further supports a vertical control knob 21 and a horizontal control knob 22. Screen bezel 13 further supports a multi-layer screen 14 comprised of a pair of transparent material planar layers such as glass or plastic 15 and 17 within which a quantity of phosphorescent material 16. It will be understood by those skilled in the art from the descriptions that follow that screen 14 may be fabricated utilizing alternative fabrications. In the embodiment shown in FIG. 1, a pair of glass layers 15 and 17 sandwich a quantity of phosphorescent material in layer 16 there between. Alternatively however, screen 14 may be fabricated of a molded plastic material within which a quantity of phosphorescent pigment is dispersed. Other fabrications may be utilized with the essential function being the provision of a transparent upper layer 14 and a layer of phosphorescent material embedded therein or in conjunction therewith.

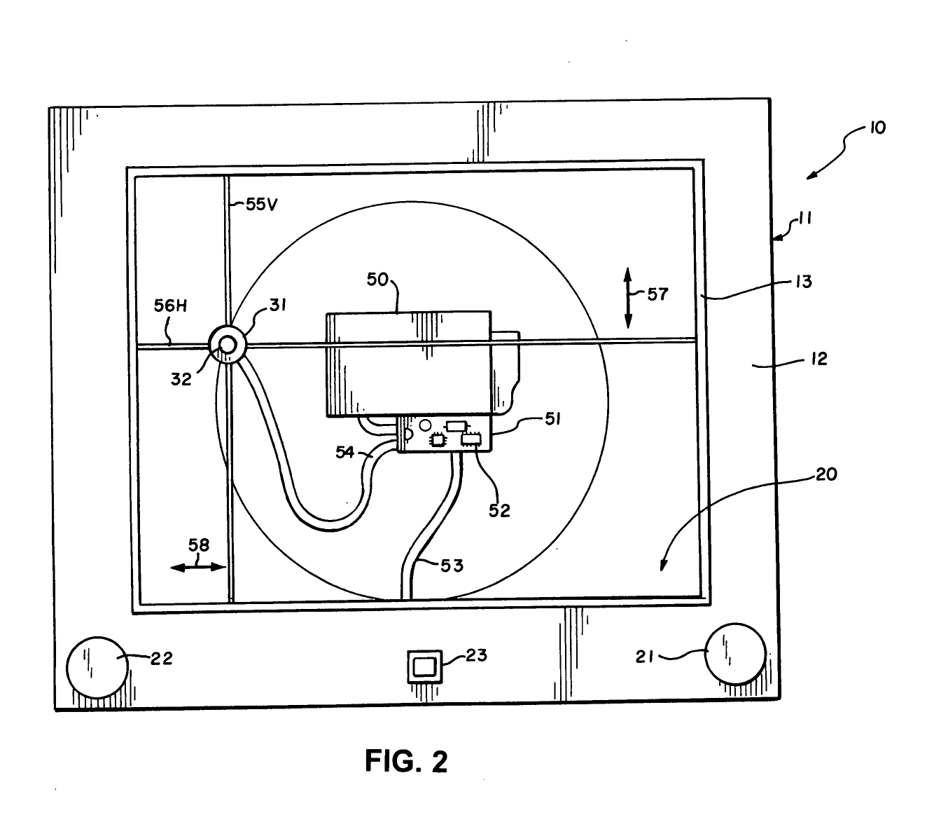

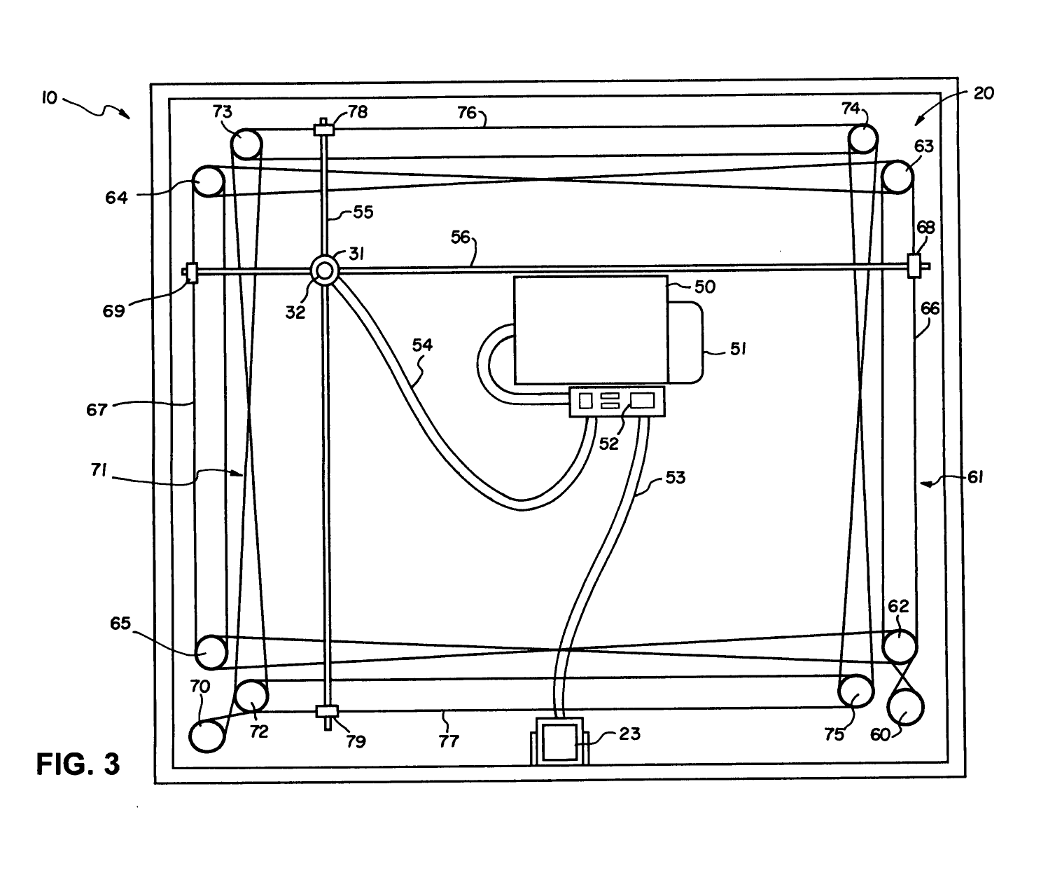

Housing 11 further includes an on/off button 23 which, by means set forth below in greater detail, is coupled to an interior power source within housing 11. As will be apparent from FIGS. 2 and 3 set forth below, apparatus 10 includes a horizontal and vertical stylus guide each of which is movable in response to vertical knob 21 and horizontal control knob 22. As is also set forth below in FIGS. 2 and 3, a stylus 31 is supported beneath screen 14 and includes an ultraviolet light emitting diode (LED). The support and movement apparatus for stylus 31 is described below in greater detail. However, suffice it to note here that stylus 31 includes an ultraviolet LED which shines upwardly upon the undersurface of screen 14 illuminating a small area thereof. The illumination provided by stylus 31 energizes phosphorescent layer 16 in the area of illumination. In accordance with the phosphorescent material characteristic of layer 16, portion of screen 14 which are illuminated by the ultraviolet LED of stylus 31 exhibit a characteristic known as “persistence” in which the phosphorescent material continues to emit light for a period of time after the initial energizing illumination has been moved. As a result, the movement of stylus 31 beneath screen 14 produces a line path or locus of points of illumination as stylus 31 is moved. Thus in the example shown in FIG. 1, commencing at an initial origin point 35 on screen 14 the user has initial rotated vertical control knob 21 clockwise in the direction indicated by arrow 40 which causes stylus 31 to move upwardly from original point 35 in the direction indicated by arrow 44. Thereafter, in the example of FIG. 1, the user has rotated horizontal control knob 22 in the clockwise direction indicated by arrow 42 causing stylus 31 to move horizontally in the direction indicated by arrow 45. Next, the user in the example of FIG. 1 has rotated vertical control knob counterclockwise in the direction indicated by arrow 41 casing stylus 31 to move downwardly in the direction indicated by arrow 46. Finally, in the example of FIG. 1, has rotated horizontal control knob 22 counterclockwise in the direction indicated by arrow 43 which in turn causes stylus 31 to move horizontally in the direction indicated by arrow 47 stopping at an end point 36. The illumination provided by stylus 31 as it is moved beneath screen 14 causes a localized energizing of phosphorescent layer 16 as the stylus moves producing a light path which provides an illuminated trace 30. Trace 30 continues to be illuminated due to the phosphorescent character of layer 16 long after stylus 31 has moved on.

In the preferred embodiment of the present invention, circuit 51 (seen below in FIG. 2) and button 23 cooperate to establish the energizing signal applied to LED 32 (also seen in FIG. 2). While a variety of patterns may be employed, the following pattern provides substantial entertainment and interest. With the initial off condition, pressing button 23 once causes circuit 51 to blink LED 32 at a fast rate. Pushing button 23 a second time causes LED 32 to be blinked at a slow rate. Pushing button 23 a third time produces a constant energizing of LED 32. A fourth press of button 23 returns LED 32 to an off condition.

In this manner, the user is able to draw a variety of drawings and figure traces upon screen 14 in a manual process similar to that enjoyed in the above-described prior art Etch A Sketch device. However, the operation of apparatus 10 provides a more interesting and amusing light illumination trace or drawing which persists for a period of time after the initial drawing process. The extent of phosphorescent persistence provided by layer 16 is to some extent a matter of design choice in selecting any of the currently available well-known phosphorescent materials. Once the user no longer cares to continue the drawing or trace being produced, the user simply waits a moment or two while the illumination of path 30 fades and apparatus 10 in essence “erases” itself without further action.

FIG. 2 sets forth a front view of the apparatus of FIG. 1 having screen 14 removed to expose interior components within apparatus 10. Thus, as described above, apparatus 10 includes a housing 11 defining a frame portion 12 which encircles a screen bezel 13. Frame portion 12 of housing 11 further supports a vertical control knob 21, a horizontal control knob 22 and an on/off button 23.

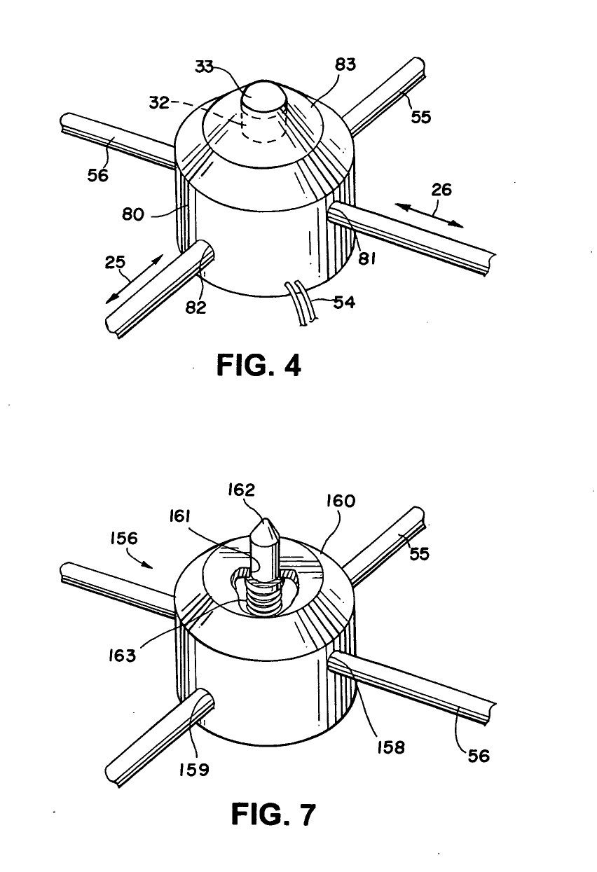

Screen 14 removed (seen in FIG. 1) interior 20 of housing 11 is exposed. Within interior 20, a vertical stylus guide 55 and a horizontal stylus guide 56 are supported in the manner set forth below in FIG. 3 in greater detail. Suffice it to note here that stylus guide 55 is movable in the directions indicated by arrows 58 in response to movement of horizontal control knob 22. Similarly, stylus guide 56 is movable in the directions indicated by arrows 57 in response to rotation of vertical control knob 21. Stylus guides 55 and 56 intersect at a stylus 31 which, as is better seen below in FIG. 4, comprises a housing formed of a material such as molded plastic or the like having bores formed therein which allows stylus 31 to be movable along stylus guides 55 and 56. As is also described below in FIG. 4 in greater detail, stylus 31 supports an ultraviolet light emitting diode 32 which is directed upwardly toward screen 14 (seen in FIG. 1). Apparatus 10 further includes a battery pack 50 and an LED circuit 51 coupled thereto. Circuit 51 is coupled to on/off button 23 by a pair of wires 53. A second pair of wires 54 couples LED circuit 51 to LED 32 within stylus 31 by conventional coupling means (not shown).

Because stylus 31 simultaneously rides upon vertical guide 55 and horizontal guide 56, stylus 31 is movable by movement of guides 55 and 56 as the intersecting point of the stylus guides is moved. Thus, as stylus guide 56 is moved in the directions indicated by arrows 57, stylus 31 is correspondingly moved on stylus guide 55. Conversely, as stylus guide 55 is moved in the directions indicated by arrows 58, stylus 31 is correspondingly moved upon stylus guide 56.

In operation, LED 32 is energized by pressing on/off button 23. Circuit 51 responds to on/off button 23 and applies operative power to LED 32 causing the above-described illumination of screen 14 (seen in FIG. 1). With LED 32 energized and screen 14 being illuminated, the area of illumination is controlled by rotation of either or both of control knobs 21 and 22. In this manner, the above-described tracing process is carried forward. While LED 32 may be either a visible light emitter or an ultra-violet light emitter, it has been found preferable to use an ultra-violet LED for most phosphorescent materials.

FIG. 3 sets forth a front view of apparatus 10 having frame portion 12 of housing 11 and screen 14 removed to completely expose interior cavity 20 and the operative stylus control mechanism within apparatus 10.

More specifically, apparatus 10 includes a housing 11 defining an interior 20 within which a battery pack 50, an LED control circuit 51 having components 52 and an on/off switch 23 are disposed. It will be apparent to those skilled in the art that the mechanism utilized and described in FIG. 3 for movement of stylus 31 in response to vertical and horizontal control knobs is derived substantially from the above-described well-known prior art device known as an Etch A Sketch. It will be equally apparent to those skilled in the art that a variety of different mechanisms may be utilized to provide movement of stylus 31 in response to control knob manipulation without departing from the spirit and scope of the present invention.

In the example shown in FIG. 3, stylus 31 is supported upon a vertical stylus guide 55 and a horizontal stylus guide 56. As is better seen in FIG. 4, stylus 31 defines orthogonal bores there through which allows stylus 31 to be received upon and move freely upon stylus guide 55 and 56. As mentioned above, stylus 31 further supports an upwardly directed ultraviolet LED which is operated by circuit 51 when button 23 is pushed. With respect to the stylus mechanism shown in FIG. 3, a quartet of pulleys 62, 63, 64 and 65 are supported within interior 20 to form a rectangular array. A pulley 60 is also supported within interior 20 and is joined to vertical control knob 21 (seen in FIG. 1). An endless cable 61 is wound about pulleys 60 and 62 through 65 such that rotation of pulley 60 in response to rotation of control knob 21 (seen in FIG. 1) produces movement of cable 61 between pulleys 62 through 65. Similarly, a second plurality of pulleys 72, 73, 74 and 75 form a second rectangular array within interior 20 of housing 11. A pulley 70 coupled to control knob 22 (seen in FIG. 1) is also supported within interior 20 of housing 11. A second endless cable 71 is wound about pulley 70 and pulleys 72 through 75 such that rotation of pulley 70 in response to rotation of control knob 22 produces corresponding movement of cable 71 between pulleys 72 through 75. Cable 61 defines a cable length 66 passing between pulleys 62 and 63 as well as a cable length 67 passing between pulleys 64 and 65. Stylus guide 56 is joined to cable lengths 66 and 67 by attachments 68 and 69. Similarly, cable 71 defines a cable length 76 passing between pulleys 73 and 74 as well as a cable length 77 passing between pulleys 72 and 75. Stylus guide 55 is secured to cable length 76 by an attachment 78 and is further secured to cable length 77 by an attachment 79.

In operation, rotation of pulley 60 produces a corresponding rotation of pulley 62 and through the coupling provided by cable 61 also causes rotation of pulleys 63, 64 and 65. The rotation of pulley 60 causes cable lengths 66 and 67 to move in the same direction thereby moving attachments 68 and 69 vertically which in turn moves stylus guide 56 vertically. Similarly, rotation of pulley 70 is coupled to pulley 72 and through the coupling provided by cable 71 a rotation of pulleys 73 through 75 is correspondingly produced. The coupling of cable 71 provides for the movements of cable lengths 76 and 77 in the same direction as pulley 70 is rotated. Thus, stylus 55 being secured to cable lengths 76 and 77 by attachments 78 and 79 results in movements of stylus guide 55 in accordance with the movements of cable lengths 76 and 77. In the selected arrangements of pulleys and cables provided in example of FIG. 3, it has been chosen that rotation of control knob 60 in a clockwise direction causes cable length 66 and 67 as well as stylus guide 56 to move upwardly. Conversely, counterclockwise rotation of pulley 60 lowers stylus guide 56. Similarly, clockwise rotation of pulley 70 produces movement of cable length 76 and 78 to the right in FIG. 3 which in turn moves stylus guide 55 to the right. Conversely, rotation of pulley 70 in a counterclockwise direction moves cable lengths 76 and 77 in a left ward direction which in turn moves stylus guide 55 to the left. In this manner, the above-described tracing action by rotation of control knobs 21 and 22 (seen in FIG. 1) produces a corresponding movement of stylus 31.

FIG. 4 sets forth a perspective view of stylus 31 supported upon stylus guides 55 and 56. Stylus 31 includes a housing 80 preferably formed of a molded plastic material or the like. Housing 80 defines a pair of orthogonal bores 81 and 82 which pass entirely through housing 80. Bore 81 receives stylus guide 56 while bore 82 receives stylus guide 55. In the preferred fabrication of the present invention, bores 81 and 82 are displaced vertically within housing 80 to avoid interference of stylus guides 55 and 56. Stylus 31 further includes a tapered head 83 within which an ultraviolet LED 32 of conventional fabrication is supported. LED 32 includes a lens 33 preferably formed integrally with LED 32. A pair of connecting wires 54 couple LED 32 to control circuit 51 (seen in FIG. 3). The coupling of wires 54 to LED 32 is carried forward in accordance with conventional fabrication techniques (not shown) with the essential characteristic being the application of suitable electrical power to LED 32. Stylus 31 is freely movable upon stylus guides 55 and 56. Thus, stylus 31 is movable in the directions indicated by arrows 26 upon stylus guide 56 and is movable in the directions indicated by arrows 25 upon stylus guide 55. In this manner, stylus 31 is movable in response to movement of stylus guides 55 and 56 described above. It will be apparent to those skilled in the art that the width of trace 30 (seen in FIG. 1) is controlled by the width of the light projected by LED 32. Thus, a thicker or thinner light trace may be formed by selecting LED 32 and the characteristics of lenses 33.

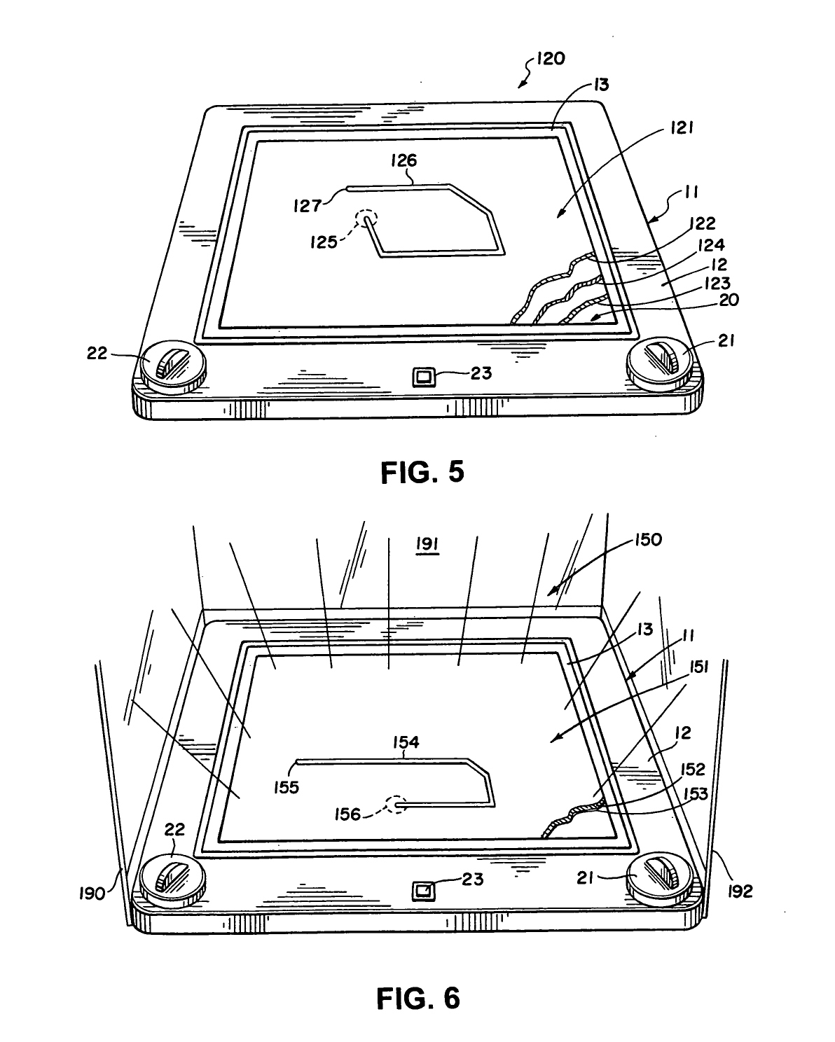

In operation, movement of stylus guides 55 and 56 provides a corresponding movement of stylus 99 to produce the simultaneous creation of three light paths shown above in FIG. 5. It will be apparent to those skilled in the art that the while the example of FIG. 6 shows a trio of LEDs, a substantial variety of LED numbers and arrangements may be provided upon stylus 98 with corresponding variation of light paths produced without departing from the spirit and scope of the present invention.

FIG. 5 sets forth a still further alternate embodiment of the present invention line drawing apparatus generally referenced by numeral 120. Apparatus 120 is substantially identical to apparatus 10 set forth above in FIG. 1 with the difference being found in the utilization of a different display screen 121. Thus, apparatus 120 includes a housing 11 defining a frame portion 12 supporting control knobs 21 and 22 together with an on/off button 23. Frame 12 supports a bezel 13 which in turn supports a multi layer display screen 121. As mentioned, apparatus 120 is substantially identical to apparatus 10 and thus will be understood to include the operative mechanisms set forth in FIGS. 2 and 3 above. Display screen 121 includes a pair of transparent layers 122 and 123 formed of a suitable glass or plastic material. A layer of ultraviolet responsive color change material 124 is captivated between layers 122 and 123. With reference to to FIG. 4, it will be noted that apparatus 120 utilizes stylus 31 with LED 32 having suitable characteristics to match the operation of color change layer 124 (seen in FIG. 5).

In operation, a stylus 31 having LED 32 described above is supported and moved beneath screen 121. Thus upon screen 121, a trace 126 is formed by moving the stylus and LED 32. The ultraviolet illumination of screen 121 provided by LED 32 causes color change in layer 124 to produce trace 126.

FIG. 6 sets forth a front view of a still alternate embodiment of the present invention generally referenced by numeral 150. Apparatus 150 is fabricated in substantial accordance with apparatus 10 set forth in FIGS. 1 through 3. Thus, apparatus 150 includes a housing 11 which defines a frame portion 12 encircling a bezel 13. Frame portion 12 further supports an on/off button 23 and a pair of control knobs 21 and 22. Apparatus 150 includes a screen 151 having a transparent layer 152 formed of a suitable glass transparent plastic material. Screen 151 further includes a quantity of luminescence powder 153 which is deposited upon the undersurface of glass 152 in a similar manner to the aluminum powder mixture utilized in original Etch A Sketch devices. Apparatus 150 differs however from conventional Etch A Sketch devices in that powder layer 153 is formed of luminescent or glow-in-the-dark material. Thus with powder layer 153 disposed upon the inner surface of glass layer 152 display screen 151 glows and emits light after being exposed to a strong light source. In accordance with the embodiment of the present invention shown in FIG. 6. A stylus 156 (seen in FIG. 3) is utilized to remove a line of powder 153 as stylus 156 is moved under the urging of the above-described cable and pulley apparatus. Stylus 156 is shown in FIG. 7 However, suffice it to note here that stylus 156 substantially in accordance with the stylus utilized in a conventional Etch A Sketch amusement device. Accordingly, with screen 151 glowing, a dark line trace 154 is formed as stylus 156 is moved from an initial point 155 in the manner shown in FIG. 12. As the finger element of stylus 156 removes the line of luminescent powder on the underside of glass 152 a dark trace 154 is formed.

Also shown in FIG. 6 is an optional foldable shield comprised of folding flaps 190, 191 and 192. Flaps 190, 191 and 192 can be folded inwardly to overly screen 151. When folded in, flaps 190, 191 and 192 cover glow in the dark screen 151 to “reset” the screen to non-glow or dark conditions. With flaps 190, 191 and 192 extending upwardly, ambient light on screen 151 is reduced enhancing the visual effect of glow from screen 151.

By way of further variation, apparatus 150 may be reversed in that powder layer 153 is formed of conventional aluminum powder and transparent layer 152 is pigmented with glow-in-the-dark material.

FIG. 7 sets forth a partially section perspective view of stylus 156 utilized in the embodiment of FIG. 6. Stylus 156 is substantially the same as the stylus utilized in the above-described Etch A Sketch prior art device. Thus, stylus 156 is passive and requires no power connection. Stylus 156 includes a housing 157 defining orthogonal bores 158 and 159 which receive stylus guides 56 and 55 respectively. Housing 157 further includes a head 160 which defines an aperture 161 therein. A finger element 162 is captivated and movable within aperture 161 and is urged upwardly by a spring 163. Stylus 156 contacts the powder-coated surface of display screen glass 152 to remove powder and “sketch” a line. It will be noted that the width of line sketched is determined by the width of the contact point on finger element 162. Thus, a more blunt point yields a thicker trace while a flat “point” yields a very thick trace.

The use of the present invention having a thicker trace (1 mm or greater) with optional traces between 1 mm to 6 mm may be directed to therapeutic uses on the part of physically or mentally challenged users as well as the aged. Toward this end, the present invention device may utilize enlarged knobs which are ergonomically designed for easier handling by young children and users with mental and physical difficulties. It will be recognized that this advantage of the present invention applies equally well to a line drawing apparatus using conventional (non-glow) powders as well.

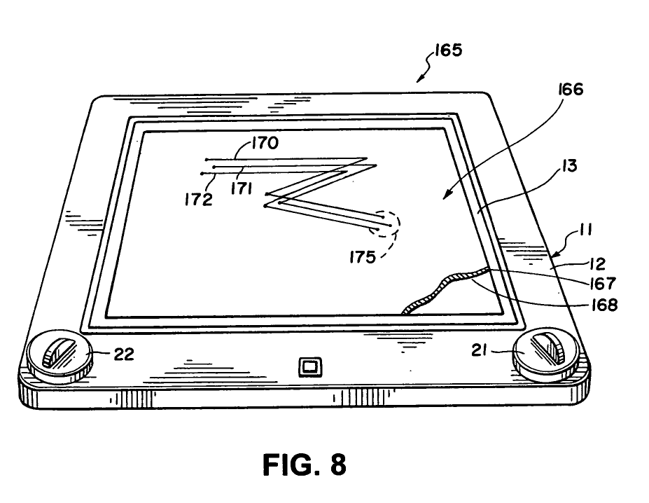

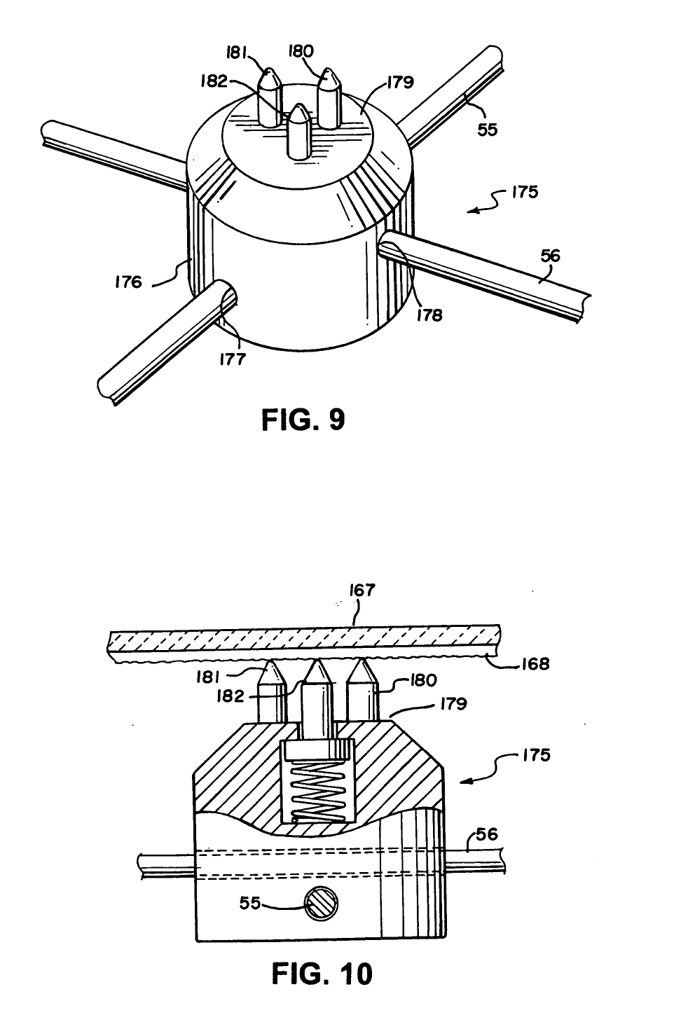

FIG. 8 sets forth a front view of a still further alternate embodiment of the present invention generally referenced by numeral 165. Apparatus 165 is fabricated in substantial accordance with apparatus 10 described above and utilizes a housing 11 having a frame portion 12 supporting control knobs 21 and 22 and a bezel 13. Bezel 13 supports a display screen 166 having a transparent layer 167 formed of a suitable plastic or glass material. Screen 166 further includes a deposited layer of powder 168 on the interior surface thereof. In accordance with embodiment of the present invention shown in FIG. 8, a stylus 175 (seen in FIGS. 9 and 10 below) is movably supported beneath screen 166 in the above-described manner. Thus, stylus 175 forms a trio of drawing lines or traces 170, 171 and 172 as stylus 175 is moved beneath transparent layer 167. As is better seen in FIGS. 9 and 10 below, stylus 175 supports a trio of finger elements which move in contact with the undersurface of transparent layer 167 wiping powder 168 from the undersurface thereof to form traces 170, 171 and 172. In accordance with the present invention, the multi trace element embodiment of the present invention shown in FIG. 8 may utilize a variety of powder layers to form layers 168 including the conventional aluminum powder mixture in prior art Etch A Sketch devices or alternatively a glow-in-the-dark powder similar to that utilized above in the embodiment of FIG. 6 may be utilized. FIG. 8 also illustrates the multiple trace paths obtained when multiple light sources are embodied in LED 32 (seen in FIG. 4).

By way of further variation of the present invention, frame 12 may be formed of a glow-in-the-dark pigmented material. This variation is believed to further enhance the visual effect of screen 166. This variation is believed to also be applicable to other of the disclosed embodiments of the present invention described herein.

With simultaneous reference to FIGS. 9 and 10, the structure of the three element stylus utilized in the embodiment of the present invention shown in FIG. 14 is illustrated. Thus, with concurrent reference to FIGS. 9 and 10, stylus 175 includes a housing 176 defining bores 177 and 178 which receive stylus guides 55 and 56 respectively. Housing 176 defines a head 179 within which a trio of finger elements 180, 181, 182 are supported. A plurality of springs such as spring 183 shown in FIG. 16 resiliently support finger elements 180, 181 and 182 against the undersurface of transparent layer 167. Because finger elements 180, 181 and 182 are each in contact with the undersurface of layer 167 a three line trace is formed as stylus 175 is moved.

What has been shown is a line drawing apparatus having considerable flexibility and multiple embodiments which provides substantial improvements upon conventional Etch A Sketch type apparatus.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention

That which is claimed is:

1. A line drawing apparatus comprising:
a base frame having an interior enclosed by a back, peripheral sides and a front;
a clear display screen supported by said front, said display screen having an interior surface and an outer surface;
a stylus having a light source;
stylus movement means movably supporting said stylus such that said light source is directed toward said interior surface and said stylus is movable about said interior surface;
stylus control means, coupled to said stylus movement means, for allowing a user to move said stylus; and
a layer of light-responsive material formed on said display screen,
said light source illuminating a portion of said display screen to form a visible path as said stylus is moved.

2. The line drawing apparatus set forth in claim 1 wherein said light source includes a single LED producing a single light path as said stylus is moved.

3. The line drawing apparatus set forth in claim 1 wherein said light source includes a plurality of LEDs producing a plurality of light paths as said stylus is moved.

4. The line drawing apparatus set forth in claim 2 wherein said layer of light-responsive material is phosphorescent and wherein said LED forms a persistent light path.

5. The line drawing apparatus set forth in claim 3 wherein said layer of light-responsive material is phosphorescent and wherein said LEDs form a plurality of persistent light paths.

6. The line drawing apparatus set forth in claim 2 wherein said layer of light-responsive material is an ultra-violet responsive color change material and wherein said LED emits ultra-violet light energy and wherein said LED forms a color changed path.

7. The line drawing apparatus set forth in claim 2 wherein said light source includes a single LED producing a single thin light path as said stylus is moved.

8. The line drawing apparatus set forth in claim 2 wherein said light source includes a single LED producing a single thick light path as said stylus is moved.

9. The line drawing apparatus set forth in claim 1 wherein said base frame includes light-shielding panels extending upwardly and generally surrounding said display screen to partially shade said display screen from ambient light.

10. A line drawing device comprising:
a base frame defining an enclosure having an interior bounded by a back, perimeter sides and a front panel;
a display screen supported by said base frame, said display screen having an inner surface and an outer surface;
a stylus including a light source;
stylus moving means within said base for supporting said stylus such that said light source is directed toward said inner surface and said stylus is moveable within said base interior; and
a layer of light-responsive material disposed upon said inner surface,
said light source illuminating a small area of said light-responsive material to cause said light-responsive material to react in a visible manner and to produce a visible path as said light source is moved.

11. The line drawing apparatus set forth in claim 10 wherein said light-responsive material is phosphorescent and said light source is an ultra-violet LED.

12. The line drawing apparatus set forth in claim 10 wherein said stylus moving means includes a vertical control for moving said stylus vertically and a horizontal control for moving said stylus horizontally.

13. The line drawing apparatus set forth in claim 12 wherein said vertical control and said horizontal control are rotatable knobs supported upon said front panel of said base frame.

14. The line drawing apparatus set forth in claim 10 wherein said light-responsive material is a color change material responsive to ultra-violet light.

15. The line drawing apparatus set forth in claim 14 wherein said light source is an ultra-violet emitting LED.

16. The line drawing apparatus set forth in claim 15 wherein said stylus moving means includes a vertical control for moving said stylus vertically and a horizontal control for moving said stylus horizontally.

17. The line drawing apparatus set forth in claim 16 wherein said vertical control and said horizontal control are rotatable knobs supported upon said front panel of said base frame.
